(19) United States
(12) Patent Application Publication
(10) Pub. No.: US 2019/0356058 A1
(43) Pub. Date: Nov. 21, 2019

(54) ANTENNA ELEMENT HAVING A SEGMENTATION CUT PLANE

(71) Applicant: Raytheon Company, Waltham, MA (US)

(72) Inventors: Larry C. Martin, Los Angeles, CA (US); Robert S. Isom, Allen, TX (US); Ralston S. Robertson, Northridge, CA (US)

(73) Assignee: Raytheon Company, Waltham, MA (US)

(21) Appl. No.: 16/415,292

(22) Filed: May 17, 2019

Related U.S. Application Data
(60) Provisional application No. 62/673,356, filed on May 18, 2018.

(51) Int. Cl. H01Q 21/06; H01Q 21/24; H01Q 1/38

(52) U.S. Cl. CPC H01Q 21/065; H01Q 1/38; H01Q 21/062; H01Q 21/24

(57) ABSTRACT

Described is a radio frequency (RF) array antenna element provided from a multi-layer printed circuit board (PCB) having disposed thereon a plurality of dual-polarized antenna elements with each of the dual-polarized antenna elements disposed to define a segmentation cut plane therebetween to enable size modification and modular construction of the RF array antenna.

### CROSS-REFERENCE TO RELATED APPLICATION(S)

This application claims priority to and the benefit of U.S. Provisional Application No. 62/673,356, filed on May 18, 2018. The entire teaching of this provisional application, and the entire teaching of U.S. application Ser. No. 15/698,929, filed Sep. 8, 2017, are incorporated herein by reference in their entirety.

### BACKGROUND

As is known in the art, in array antennas, performance is often limited by the size and bandwidth limitations of the antenna elements which make up the array. Further, packaging volume constraints often require low profile antenna structures. Improving bandwidth while maintaining a low profile, which meets volume constraints, enables array system performance to meet bandwidth, scan, and volume packaging requirements of next generation communication systems, such as software defined or cognitive radio.

Attempts have been made to fabricate low profile antenna elements and array antennas. Such array antennas include an array of tightly coupled dipole elements which approximates the performance of an ideal current sheet, as well as so-called “bunny ear” antennas, and tightly coupled patch arrays. While these antenna element designs are all low profile, they either fail to operate over a desired bandwidth or require complex feed structures to support either dual linear or circular polarizations (e.g. requiring external components difficult to fit within the antenna element of an array antenna). Other antenna elements, such as Vivaldi notch antenna elements, can provide a relatively wide bandwidth, but are not low profile.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In an aspect, a radio frequency (RF) array antenna element provided from a multi-layer printed circuit board (PCB) having disposed thereon a plurality of dual-polarized antenna elements with each of the dual-polarized antenna elements disposed to define a segmentation cut plane therebetween. The antenna elements may be cut or otherwise divided along segmentation cut plane without destroying the function of the antenna element. Such an antenna element may be used in a unit cell and a plurality of unit cells having segmentation cut planes may be used to provide an array antenna having a segmentation cut plain. Since the inclusion of a segmentation cut plane in an antenna elements and/or unit cell allows the antenna element/unit cell to be cut or otherwise divided without destroying the function of the antenna element and/or unit cell, inclusion of a segmentation cut plane in antenna elements and/or unit cells enables size modification and modular construction of an array antenna.

Described herein is a radio frequency (RF) array antenna element that has a multi-layer printed circuit board (PCB) which can have disposed thereon a plurality of dual-polarized antenna elements. Each of the dual-polarized antenna elements disposed on the multi-layer PCB can define a segmentation cut plane therebetween to enable size modification and modular construction of the RF array antenna. The RF array antenna further has an artificial dielectric layer (ADL) that can be disposed on the plurality of antenna elements. The ADL can comprise one or more dielectric layers and one or more metallic surface layers disposed thereover.

In some instances, the RF array antenna element can have a segmentation cut plane that is aligned in a region of the dual-polarized antenna elements which is non-conductive. In other instances, the RF array antenna can have a multi-layer PCB that can include a lower conductive assembly that has first and second opposing surfaces, and a dipole layer that has first and second opposing surfaces with the first surface disposed over the second surface of the lower conductive assembly. In these instances, the ADL can have first and second opposing surfaces, where the first surface of the ADL can be disposed over the second surface of the dipole layer. The segmentation cut plane can extend from the second surface of the ADL through the first surface of the lower conductive assembly. Furthermore, in some embodiments, the segmentation cut plane can be located between first and second conductive vias which extend from the second surface of the dipole layer to the first surface of the lower conductive assembly.

Also described herein is a unit cell that can be used in a radio frequency (RF) array antenna, where the unit cell includes a multi-layer printed circuit board that has a first layer that corresponds to an antenna element layer, and where the multi-layer printed circuit board has disposed thereon one or more conductors responsive to RF signals having first and second orthogonal polarizations with the one or more conductors disposed to define a segmentation cut plane. The multi-layer printed circuit board can further include one or more secondary layers corresponding to feed layers and two or more feed circuits disposed thereon. A first one of the secondary layers can have two or more feed circuits that are electrically coupled to a first one of the conductors and responsive to signals having a first polarization. A second one of the secondary layers can have two or more feed circuits that are electrically coupled to a second one of the conductors and responsive to signals having a second polarization which is orthogonal to the first polarization. The two or more feed circuits can be disposed to define a segmentation cut plane which is aligned with the segmentation cut plane defined by the conductive elements disposed on the antenna element layer. Also included in the multi-layer printed circuit board is an artificial dielectric layer (ADL) disposed on the plurality of antenna elements, wherein the ADL comprises one or more dielectric layers and one or more metallic surface layers disposed thereover with conductors on the metallic surface layers configured such that a conductor does cross the segmentation cut plane defined by the conductive elements disposed on the antenna element layer and the feed circuits of the feed circuit layers.

In some embodiments, the unit cell can include an antenna element where the feed circuit are disposed such that the segmentation cut plane does not cross any conductive elements. In these embodiments, the feed circuit can be a coaxial signal path, the segmentation cut plane can be non-conductive, the one or more conductors can be printed circuit conductors, the antenna element layer can be a dipole layer, and the feed layer can be a dipole layer.

In other embodiments, the multi-layer printed circuit board can include a lower conductive assembly that has first and second opposing surfaces, a dipole layer that has first and second opposing surfaces with the first surface of the diploe layer disposed over the second surface of the lower conductive assembly, and an ADL that has first and second opposing surfaces where the first surface of the ADL can be disposed over the second surface of the dipole layer. In these embodiments, the segmentation cut plane can extend from the second surface of the ADL through the first surface of the lower conductive assembly.

In still other embodiments, the unit cell can include a segmentation cut plane that is located or otherwise disposed between first and second conductive vias which extend from the second surface of the dipole layer to the first surface of the lower conductive assembly.

Yet another embodiment described herein is an array antenna that has a plurality of antenna sections that each can comprise a plurality of unit cells. At least some of these unit cells can have a segmentation cut plane. The unit cells can comprise a multi-layer printed circuit board that has a first layer that corresponds to an antenna element layer. The antenna element layer can have disposed thereon one or more conductors that are responsive to RF signals that can have first and second orthogonal polarizations with the one or more conductors disposed to define a segmentation cut plane. In some instances, the multi-layer printed circuit board can have one or more secondary layers that correspond to feed layers and having two or more feed circuits disposed therethrough with a first one with the two or more feed circuits electrically coupled to a first one of the conductors and responsive to signals having a first polarization and a second one with the two or more feed circuits electrically coupled to a second one of the conductors and responsive to signals having a second polarization which is orthogonal to the first polarization, the two or more feed circuits disposed to define a segmentation cut plane which is aligned with the segmentation cut plane defined by the conductive elements disposed on the antenna element layer. The multi-layer printed circuit board can further include an artificial dielectric layer (ADL) that can be disposed on the plurality of antenna elements. The ADL can comprise one or more dielectric layers and one or more metallic surface layers disposed thereover with conductors on the metallic surface layers configured such that a conductor crosses the segmentation cut plane defined by the conductive elements disposed on the antenna element layer and the feed circuits of the feed circuit layers.

In some embodiments, the one or more conductors can be disposed on the antenna element layer and the two or more feed circuits are disposed such that the segmentation cut plane does not cross any conductive elements. In other embodiments, one or more conductors are disposed on the array antenna, each of the two or more feed circuits comprise a coaxial signal path, the segmentation cut plane is non-conductive, and the one or more conductors are printed circuit conductors.

In other instances, the multi-layer printed circuit board of the array antenna includes a lower conductive assembly that can have first and second opposing surfaces, and an antenna layer that can have first and second opposing surfaces where the first surface of the antenna layer is disposed over the second surface of the lower conductive assembly. Further included can be the ADL which can have first and second opposing surfaces where the first surface of the ADL can be disposed over the second surface of the antenna layer, and a segmentation cut plane that can extend from the second surface of the ADL through the first surface of the lower conductive assembly.

In still other instances, the lower conductive assembly of the array antenna can comprise first and second conductive vias which extend from the second surface of the antenna layer to the first surface of the lower conductive assembly. The segmentation cut plane can be located or otherwise disposed on a plane that is between the first and second conductive vias.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1A is an isometric view of a portion of a planar array antenna having a plurality of segmentation cut planes;

FIG. 1B is an isometric view of a portion of a planar array antenna having a plurality of segmentation cut planes and an artificial dielectric layer;

FIG. 2 is an isometric view of a portion of an antenna element having a segmentation cut plane.

FIG. 3 is an isometric view of a portion of an antenna element having a segmentation cut plane.

FIG. 4 is an isometric view of a portion of an antenna element having a segmentation cut plane.

FIG. 5 is an isometric view of a portion of an array antenna provided from a panel of radiating elements having a segmentation cut planes.

FIG. 6 is top view of a panel of radiating elements illustrating various sizes of array antennas which may be fabricated by cutting portions of the panel along various, different segmentation cut planes.

FIG. 7 is a cross-sectional view of a portion of an array antenna provided from a multi-layer circuit board having segmentation cut planes.

FIG. 8 is a flow diagram of a process for fabricating an array antenna from a multi-layer circuit board having segmentation cut planes.

FIG. 9 is an exploded, isometric view of a planar array antenna having a plurality of segmentation cut planes and an artificial dielectric layer.

FIG. 10A is an isometric view of a planar array antenna having a plurality of segmentation cut planes.

FIG. 10B is an isometric view of a planar array antenna having a segmented quadrants.

### DETAILED DESCRIPTION

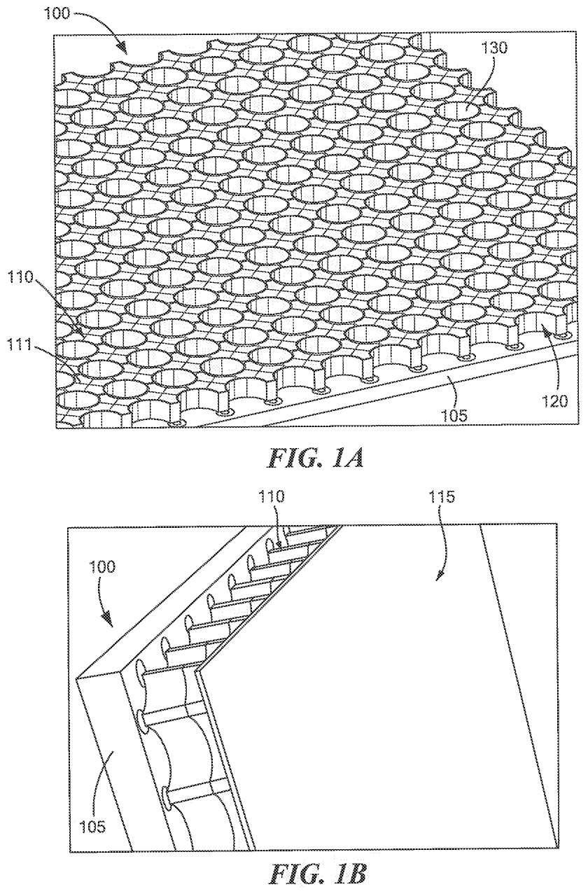

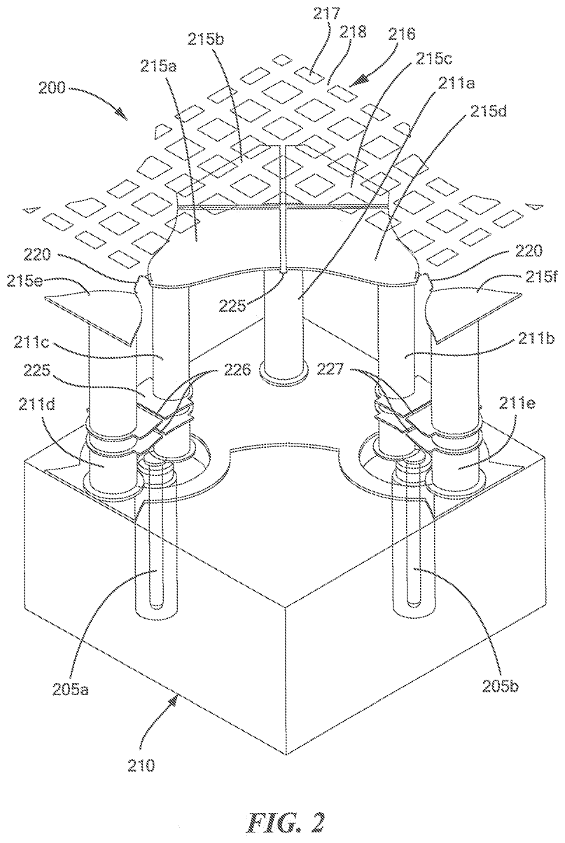

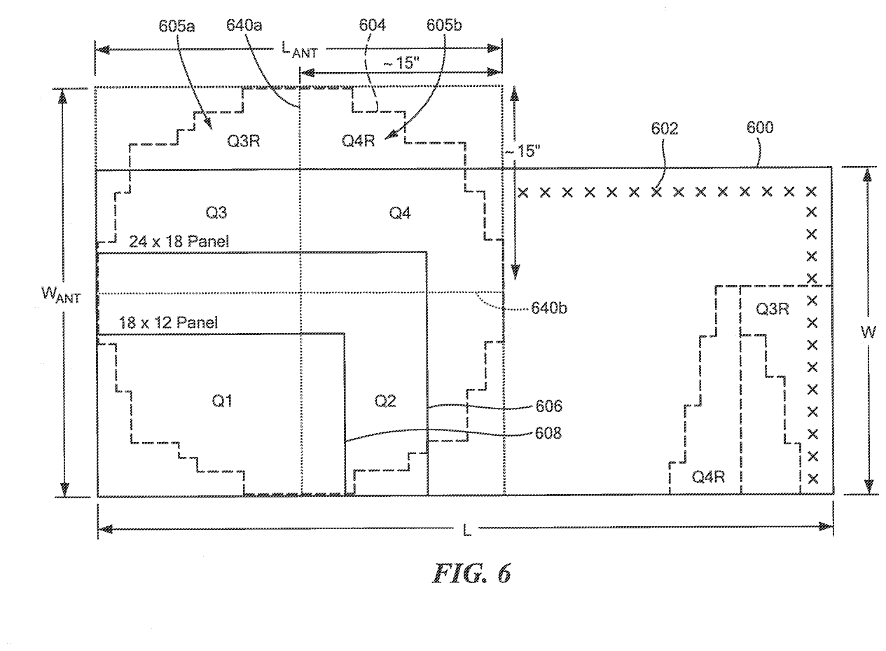

Referring now to FIG. 1A, a portion of a planar array antenna 100 comprises an array of antenna elements 120 disposed over a ground plane 105. As will be described in detail below in conjunction with FIGS. 2-4, some of all of antenna elements 120 are part of a unit cell and include a segmentation cut plane (i.e. the antenna elements and thus the unit cell include a segmentation cut plane). As will be described in conjunction with FIG. 6, segmentation cut planes allow an array antenna (e.g. array antenna 100) to be provided from a wide range of antenna elements and also allows an array antenna to have a wide range of different shapes including, but not limited to rectangular shapes. square shapes, octagonal shapes and potentially any regular geometric shape depending upon the particular size and/or shape of the antenna element as well as the location of the segmentation cut plane on the antenna element. Further, the antenna elements which form an array antenna (e.g. array antenna 100) may be cut or otherwise provided from a single sheet of antenna elements. Accordingly, the ability to provide an array antenna having a certain shape is also dependent, at least in part, upon the number of antenna elements in such a sheet which include a segmentation cut plane. It thus follows that maximum flexibility in providing array antenna shapes (or providing array antenna shapes having a certain desired shape) is provided by having every antenna element (or each unit cell) in such a sheet include a segmentation cut plane. An example of such a sheet and how array antenna of varying sizes and shapes may be provided will be described below in conjunction with FIG. 6.

Referring now to FIG. 1B, an artificial dielectric layer (ADL) 115 is disposed over array antenna 100. ADL 115 may be provided having a metallic surface layer (not visible in FIG. 1B) comprising an array of metallic patches provided on a first surface a dielectric layer the ADL 115. Such an ADL dielectric layer can be a multi-layered dielectric comprising a top layer, an intermediate layer, and a bottom layer provided from materials know to those of ordinary skill in the art. The ADL is provided having a thickness selected to provide a Wide Angle Impedance Matching (WAIM).

Referring now to FIG. 2, only electrical conductors which form a unit cell 200 of an antenna. That is, other than element 210, dielectric materials (such as those shown in FIGS. 1A, 1B) are not visible in FIG. 2. Those of ordinary skill in the art will appreciate, of course, that conductors are supported by dielectric materials.

Unit cell 200 can include an antenna element provided from conductors 215a-215d. Antenna elements 215a, 215d are fed via feed circuits provided from feed lines 205a, 211c and 205b, 211b, respectively. Conductors 215e, 215 are also antenna elements (or portions of antenna elements) and may be coupled (directly or indirectly), to conductors on adjacent unit cells. Conductors 215e, 215 are coupled to respective ones of coaxial lines

The antenna element (and thus unit cell) can includes segmentation cut planes defined by spaces (or gaps) 220, 226, 227 in or between the conductors which comprise the unit cell. The segmentation cut planes are disposed such that if the antenna element (or unit cell) are cut or otherwise separated along these planes, a desired electrical performance of an array antenna which includes the cut antenna element/unit cell) is maintained.

The antenna element/unit cell also includes conductors 216-218 which correspond to conductors on an artificial dielectric layer (ADL) (e.g. ADL 115 in FIG. 1). Conductors 225 can correspond to impedance matching structures.

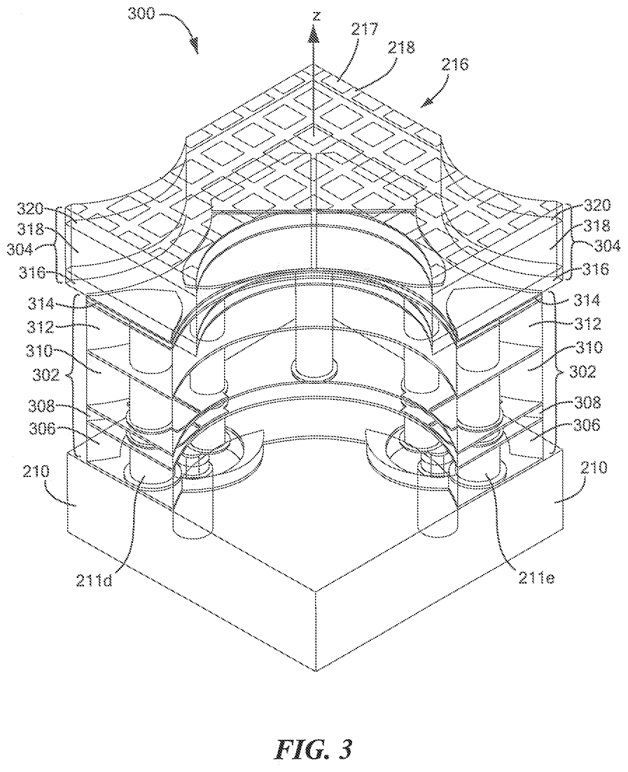

Referring to FIG. 3, shown is a unit cell 300 which may be the same as or similar to unit cell 200 described above in conjunction with FIG. 2. In FIG. 3, both dielectric and electrically conductive elements (i.e. electrical conductors) are shown.

Unit cell 300 can include first and second portions 302, 304. The first portion 302 comprises an antenna circuitry including dielectric layers 306-314 and conductors which form antenna elements (e.g. conductors 215a-215f in FIG. 2), and feed circuits (e.g. conductors 211a-211e) which may be provided as coaxial transmission lines. The second portion 304 comprises one or more frequency selective surface (FSS) layers. In this illustrative example, second portion 304 comprises three dielectric layers 316-320. Conductors may be disposed on any or all of the surfaces of the dielectric materials. Such an arrangement results in an antenna element having a relatively low-profile and which can operate over a frequency bandwidth and scan volume which are relatively wide compared with prior art antennas having a similar low profile.

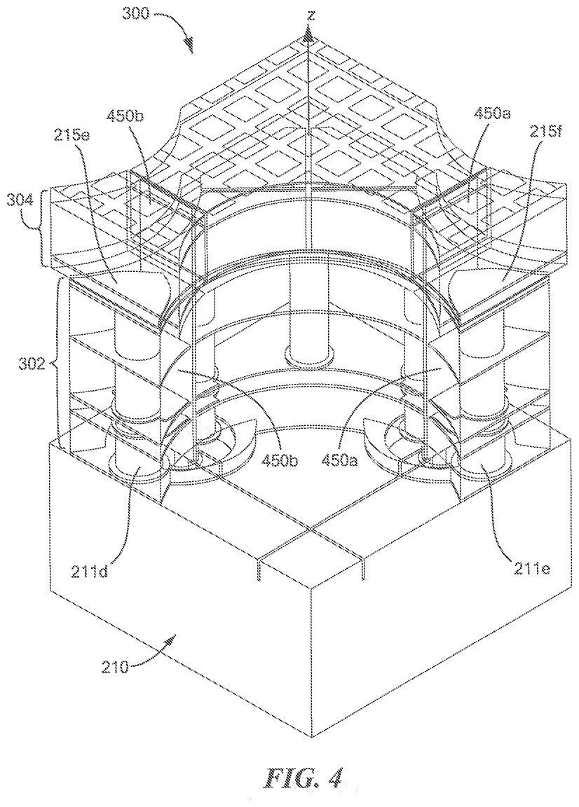

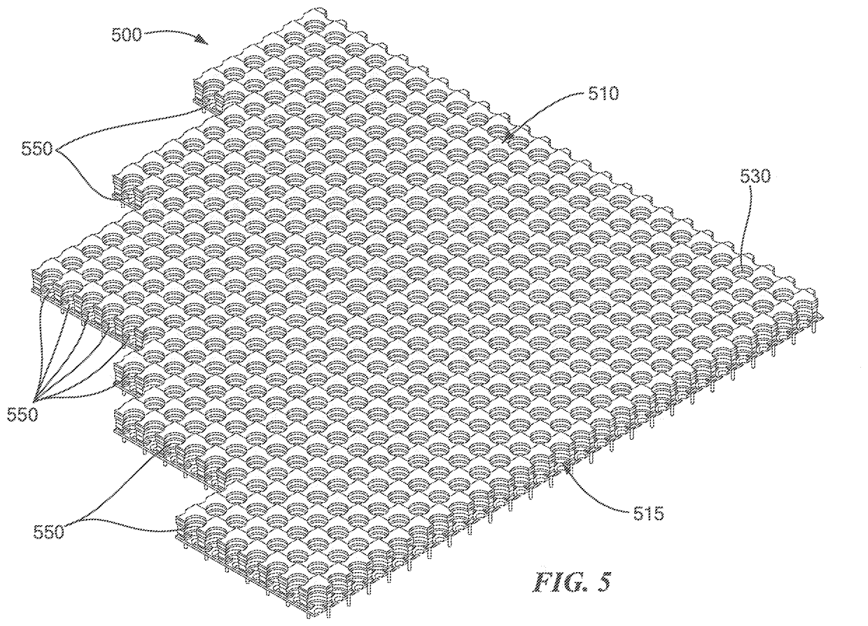

Significantly, and as will be clearly illustrated in FIG. 4, all conductors can be arranged such that they do not continuously cross a segmentation cut plan.

Turning now to FIG. 4, in which like elements of FIGS. 2 and 3 are provided having like reference designations, a pair of segmentation cut planes 450a, 450b are illustrated. It should be appreciated that elements 45oa, 450b are not structures within the until cell 300, rather elements 450a, 450b in FIG. 4 merely visually illustrate segmentation cut planes defined by placement of conductive and dielectric structures (as described above in conjunction with FIGS. 2 and 3 above, which are part of the unit cell).

Referring now to FIG. 5, a plurality of antenna elements 510 may be fabricated in a sheet 500 of dielectric material. The sheet 500 of dielectric material may be, for example, a multi-layer printed circuit board. Some or all the antenna elements 550 may be provided having segmentation cut planes which may be the same as or similar to the segmentation cut planes described above in conjunction with FIGS. 2-4. Thus, sheet 500 may be cut along segmentation cut planes to form a desired shape.

In the illustrative embodiment of FIG. 5, cuts have been made in regions 515, 530 and 550 to provide antenna 500 having a desired shape.

Referring now to FIG. 6, a sheet 600 (also sometimes referred to as panel 600) which may be, for example, a multi-layer printed circuit board having a length L and a width W has formed or otherwise provided therein a plurality of antenna elements 602 with at least some of the plurality of antenna elements having segmentation cut planes (not numbered) formed therein. The antenna elements and thus segmentation cut planes may be the same as or similar to the types described above in conjunction with FIGS. 2-4.

A desired antenna shape 604 (i.e. an outline of a perimeter of an antenna) is superimposed over sheet 600. Thus, an antenna having dimensions L_{ANT}×W_{ANT} cannot be formed directly from a sheet having dimensions L×W where W_{ANT}>W. The desired antenna shape 604 can be any uniform or non-uniform shape. For example, the shape can be rectangular, square, trapezoidal, circular, triangular, pentagonal, hexagonal, octagonal, nonagonal and decagonal. The shape can be equiangular or equilateral; or have rounded or pointed edges. In still other instances, the shape 604 can occupy a closed area bound by a series of lines and/or curves.

For example, sheet 600 maybe 54 inches×24 inches (L×W) inches and the desired antenna dimensions may be 30 inches×30 inches (L_{ANT}×W_{ANT}). Thus, while an entire antenna having dimensions L_{ANT}×W_{ANT} cannot be formed directly from a sheet having dimensions L×W where W_{ANT}>W, it is possible to forms portions of the antenna from sheet 600.

For example, considering the antenna quadrants Q1-Q4 defined by dashed lines 640a, 640b, one can see that two full antenna quadrants Q1, Q2 and portions of antenna quadrants Q3, Q4 may be formed from sheet 600. However, remainder portions of antenna quadrants (denoted as Q3R, Q4R) are outside the boundaries of sheet 600.

Thus, full antenna quadrants Q1, Q2 may be cut or otherwise separated from sheet 600 with quadrant Q1 being shown in FIG. 5) by cutting sheet 600 along segmentation cut planes. As noted above, by cutting along segmentation cut planes, operable unit cells result. Similarly, partial antenna quadrants Q3, Q4 may be cut or otherwise separated from sheet 600 cutting sheet 600 along segmentation cut planes. Similarly still, partial antenna quadrants Q3R, Q4R may be cut or otherwise separated from another portion of sheet 600 (i.e. regions generally denoted 611a, 611b) by cutting sheet 600 along segmentation cut planes.

The antenna sections may then be mechanically and electrically joined to form a full array antenna having the desired antenna shape denoted 604.

Other panel sizes may, of course, also be used. For example an illustrative panel 606 may have dimensions L1×W1 where L1 is less that the length of two antenna quadrants and W1 is less than the width of two antenna quadrants (e.g. a panel having dimensions of 24×18). Or an illustrative panel 608 may have dimensions L2×W2 where L2 is less that the length of two antenna quadrants and W2 is less than the width of one antenna quadrant (e.g. a panel having dimensions of 18×12).

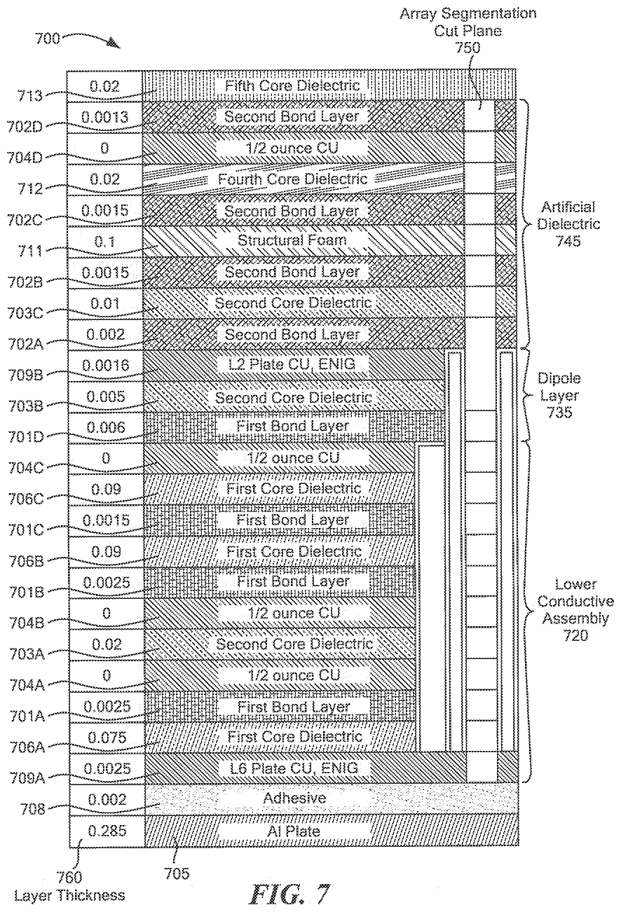

Illustrated in FIG. 7 is a cross-sectional view of an array antenna element 700 that has a lower conductive assembly 720, a dipole layer 735 and an artificial dielectric layer 745. The lower conductive assembly 720 can have a lower copper layer with a protective finish 709A, bond layers 701A-C and multiple core dielectric layers 706A-C, 703A, 704A-C that can be a first core dielectric 706A-C, a second core dielectric 703A and a layer of one-half (½) ounce copper (CU) 704A-C. The dipole layer 735 includes a bond layer 701D, a second core dielectric layer 703B and a copper layer with a protective finish 709A. The artificial dielectric 745 can include bond layers 702A-D, core dielectric layers 703C, 712, 702D, and structural foam 711. Disposed overtop the artificial dielectric 745 can be another dielectric layer, the fifth core dielectric 713. The array antenna element 700 can be mounted or otherwise disposed on an aluminum plate 705 and manufactured into the array antenna 700 can be an array segmentation cut plane 750. Disposed between the aluminum plate 705 and the lower copper layer 709A of the lower conductive assembly 720 is an adhesive layer 708. Each layer of the antenna element 700 can have a thickness such as those exemplary layer thicknesses 760 demonstrated in FIG. 7 (in which dimensions are in inches).

Further referring to FIG. 7, and in more detail, the array antenna element 700 can be referred to as a radio frequency array antenna element, an antenna element, a unit cell, a broadband array antenna element, or any other similar type of array antenna element. The array antenna element 700 can be mounted or otherwise disposed on any structural member. As shown, an aluminum plate 705 can be used, while in other embodiments the plate can be manufactured from alternative materials. Mounting the array antenna element 700 to the aluminum plate 705 can be facilitated using an adhesive layer 708 which can be a thermally and electrically conductive adhesive such as Coolspan® TECA. It should be appreciated that any suitable, thermally and conductive adhesive can be used. Curing may be required to fully bond the adhesive layer 708 to the array antenna element 700 and the aluminum plate 705. In other embodiments, an adhesive layer 708 is not needed and the antenna element 700 can be secured or otherwise disposed on the aluminum plate 705 using chemical means such as fusion bonding or mechanically means such as sweat soldering or mechanical or press fit metal attachment.

In some embodiments, the lower layer 709A of the lower conductive assembly 720 can be mounted to the aluminum plate 705 using the adhesive layer 708. This lower plate 709A can be a surface plating disposed overtop of the printed circuit board. For example, the lower layer 709A can comprise electroless nickel immersion gold (ENIG) or a similar surface plating. This lower layer 709A can be lowest layer of the lower conductive assembly 720.

The lower conductive assembly 720, dipole layer 735, artificial dielectric 745 and fifth core dielectric 713 can comprise one or multiple layers of a core dielectric. A core dielectric can be a layer of dielectric material having a suitable dielectric constant. For example, the core dielectric can be a high frequency laminate such as any of those manufactured by Rogers Corporation. In some instances, the core dielectric material can have a low coefficient of thermal expansion thereby ensuring that vias or holes bored into the material will retail their size and shape. In other instances, the core dielectric material can be dimensionally stable such that temperature changes will not cause the dimensions of the array antenna element 700 and any vias bored into the array antenna element 700 to significantly change.

In some instances, one or more of the core dielectric layers can be separated by a layer of ½ ounce copper (CU) 704A-D.

In one embodiment the first core dielectric 706A-C, second core dielectric 703A-C, fourth core dielectric 712 and fifth core dielectric 713 can be manufactured from different dielectric materials. It should be appreciated, however, that the first core dielectric 706A-C, second core dielectric 703A-C, fourth core dielectric 712 and fifth core dielectric 713 can be manufactured from the same dielectric material. Furthermore, any two or three or four of the first core dielectric 706A-C, second core dielectric 703A-C, fourth core dielectric 712 and fifth core dielectric 713 can be manufactured from the same dielectric material, while the other core dielectrics are manufactured from a different dielectric material. The dielectric layers can be manufactured from filled composite laminates such as the RT/Duroid® materials, or R04000® laminates manufactured by the Rogers Corporation.

The layers of core dielectric material can have thicknesses in a range of 0.001 to 0.285 inches. In other embodiments, the dielectric material can have any thickness suitable for creating the array antenna element 700.

The various core dielectric layers 706A-C, 703A-C, 712, 713 can have copper plating disposed thereon. In some embodiments the copper plating can be disposed on both sides of the core dielectric layer, in other embodiments the copper plating is disposed on only one side of the core dielectric layer. During fabrication of the array antenna element 700 the copper plating can be etched off the core dielectric layer such that substantially all the copper plating can be removed from the core dielectric layer. In other embodiments, a portion of the copper plating can be etched off of the core dielectric layer, and in still additional embodiments RF patterns or artwork can be etched into the copper plating.

Disposed in between the various core dielectric layers are bond layers 701A-D, 702A-D. These bond layers 701A-D, 702A-D can be any adhesive system able to adhere one dielectric layer to another. In some instances, the bond layers 701A-D, 702A-D can be manufactured from the same adhesive material, while in other embodiments they can be manufactured using different adhesive materials. The adhesive material can be a thermoset based thin film adhesive system that are compatible with the core dielectric materials described herein. In one embodiment, the bond layers 701A-D, 702A-D can comprise Bondply manufactured by Rogers Corporation.

Disposed on top of the artificial dielectric 745 can be a layer comprised of a fifth core dielectric 713.

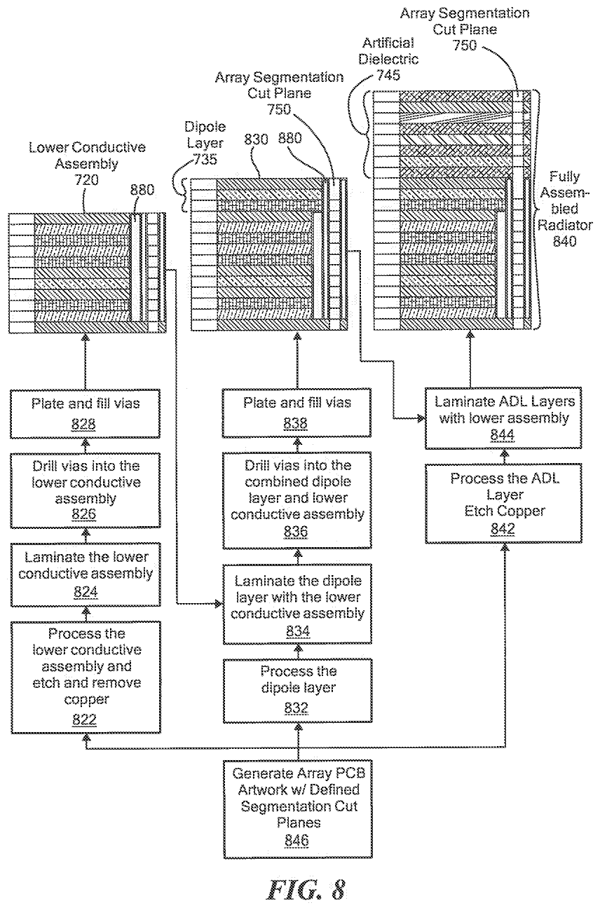

Illustrated in FIG. 8 is a process for manufacturing the array antenna element 700 having segmentation cut plane as described herein. In one instance, the lower conductive assembly 720 can be created by first processing the layers of the lower conductive assembly 720 (step 822), then laminating the lower conductive assembly (step 824) and drilling vias 880 into the lower conductive assembly (step 826) then plating and filling the drilled vias 880 (step 828).

The manufactured lower conductive assembly 720 can be incorporated into the array antenna element 700 during the manufacturing of the dipole layer 735 such that the lower conductive assembly 720 and the dipole layer 735 form a single element 830. In one instance, artwork or patterns for the array antenna element 700 is generated (step 846). The generated artwork or patterns are then used to process the radiation surface 830 of the dipole layer 735 (step 832), then the processed dipole layer 735 can be laminated together with the lower conductive assembly 720 (step 834). After lamination, vias 880 are drilled into the combined structure 830 of the dipole layer 735 and lower conductive assembly 720 (step 836) and the drilled vias 880 are then plated and filled (step 838).

The combined structure 830 can be included in the fully assembly radiator 840 during the manufacturing of the artificial dielectric layer 745. Layers within the artificial dielectric layer 745 can be processed (step 842) and then the combined structure 830 can be laminated together with the artificial dielectric layer (ADL) 745 to form a fully assembled radiator 840 (step 844). In some embodiments, the process illustrated in FIG. 8 can further include the step of mounting the assembled radiator 840 to an aluminum base 705 using an adhesive 708, and/or disposing a fifth core dielectric layer 713 overtop of the artificial dielectric layer 745.

Further referring to FIG. 8, and in more detail, in some instances, processing the layers of the lower conductive assembly 720 (step 822), processing the layers of the dipole layer 735 (step 832) and processing the layers of the ADL 745 can include etching copper off of one or more of the core dielectric layers. In some instances, processing can include etching substantially all of the copper off of one or both sides of a dielectric layer, while in other embodiments, processing can include imparting a pattern or RF artwork to a dielectric layer by etching the pattern or artwork into the layer. Etching can include drying etching or chemical etching.

Processing can also refer to the process of stacking various core dielectric layers and bonding layers. For example, processing the lower conductive assembly 720 (step 822) can include disposing on top of plating or a layer of electroless nickel immersion gold (ENIG) a first layer of a first core dielectric 706A. A layer of the first bond layer 701A can then be affixed onto a side of the first layer of the first core dielectric 706A layer and a layer of ½ ounce CU 704A can be disposed on the first layer of the first bond layer 701A. A layer of the second core dielectric 703A is then affixed to the opposite side of the layer of ½ ounce CU 704A. A second layer of % ounce CU 704B is then affixed to the other side of the layer of second core dielectric 703A. Layered on top of the second layer of % ounce CU 704B is a second layer of the first bond layer 701B which is bonded on the other side to a second layer of the first core dielectric 706B. A third layer of the first bond layer 701C is disposed on the opposite side of the second layer of the first core dielectric 706B and affixed to the other side of the third layer of first bond layer 701C is a third layer of the first core dielectric 706C. Disposed on the third layer of the first core dielectric 706C is a third layer of ½ ounce CU 704C. It should be appreciated that the lower conductive assembly 720 can include any number of core dielectric layers and bond layers arranged in any order. Additionally, the lower conductive assembly 720 can include additional conductive and insulation layers not shown. It should be appreciated that while the above process describes disposing one or more layers of ½ ounce CU 704A-D, in some instances, the layer of ½ ounce CU 704A-D need not be disposed on a dielectric layer because the dielectric layer already has a layer of ½ ounce CU thereon. For example, in some instances, dielectric layers are manufactured and therefore purchased from a manufacturer with a layer of copper on one or both sides of the layer. Thus, in some instances, the process may not include the additional steps of disposing and adhering a layer of copper to the dielectric because the dielectric was acquired with a layer of copper already disposed thereon.

Once the layers of the lower conductive assembly 720 are processed, and all excess copper is removed (step 822) from the various core dielectric layers, the lower conductive assembly can be laminated (step 824). The process of lamination can include placing the assembly 720 under an amount of pressure and/or increasing the temperature of the assembly's environment to cause the various bonding layers 710A-C to melt and laminate the various core dielectric layers together. Once laminated, vias 880 can be drilled into the lower conductive assembly 720 (step 826). Vias 880 can be holes or through holes that in some embodiments can be used to electrically connect electrical components or elements to aspects of the dielectric layers. In this instance, the vias 880 can be used to build the array segmentation cut plane 750. Drilling can be accomplished using any mechanical means. In some instances, the vias 880 can be filled and plated (step 828) which can include filling the vias 880 with a material such as Kapton or permitting the vias 880 to be filled with air.

Processing the dipole layer 735, on the other hand, can include etching a previously manufactured RF pattern or artwork onto a second layer of the second core dielectric material 703B (step 832). This pattern or artwork can be created prior to the manufacturing process (step 846) and can include defined segmentation cut planes 750 for the array antenna element 700. Etching can be done on the copper layer 709B of the second layer of the second core dielectric 703B, and the dipole layer 735 can be bonded to the lower conductive assembly using the fourth layer of the first bond layer material 701D. It should be appreciated that the dipole layer 735 can include any number of core dielectric layers and bond layers arranged in any order. Additionally, the dipole layer 735 can include additional conductive and insulation layers not shown.

Once the layers of the dipole layer 735 are processed (step 832) the dipole layer 735 can be laminated together with the lower conductive assembly 720 (step 834). Lamination can include placing the dipole layer 735 on the lower conductive assembly 720 such that a fourth layer of the first bond layer material 701D is disposed between a side of the third layer of ½ ounce CU 704C and a side of the second layer of the second core dielectric material 703B. Once the dipole layer 735 is situated in physical communication with the lower conductive assembly 720, the two layers are exposed to an increase in pressure and/or temperature that causes the bond layer 701D between the lower conductive assembly 720 and the dipole layer 735 to melt and laminate the two assemblies together to form a single combined structure 830.

Once the dipole layer 735 and the lower conductive assembly 720 are laminated together to form the combined structure 830, vias 880 or holes are drilled into the combined structure 830 (step 836) using any mechanical means. The vias are then plated and filled (step 838) using any material or method described herein. The PCB artwork that was applied to the dipole layer 735 (step 832) defines an array segmentation cut plane 750 that is visible after the vias are drilled (step 836) and filled (step 838).

Processing the artificial dielectric layer 745 (step 842) can include assembling the artificial dielectric layer 745. This can include bonding, via a layer of second bond layer material 702B a third layer of the second core dielectric material 703C to a structural foam layer 711. The structural foam layer 711 can also be bonded via another layer of the second bond layer material 702C, to a layer comprising a fourth core dielectric material 712. Disposed on the other side of the fourth core dielectric material 712 can be a fourth layer of ½ ounce CU 704D having a fourth layer of the second bond layer 702D disposed on the fourth layer of ½ ounce CU 704D. The artificial dielectric layer 745 can be bonded to the dipole layer 735 via a first layer of the second bond layer material 702A disposed between the copper plating 709B of the second layer of the second core dielectric 703B and the third layer of the second core dielectric material 703C. Processing the ADL 745 can include etching away copper or drilling vias to better delineate the array segmentation cut plane 750. It should be appreciated that the artificial dielectric layer 745 can include any number of core dielectric layers and bond layers arranged in any order. Additionally, the artificial dielectric layer 745 can include additional conductive and insulation layers not shown. As was previously stated, in some embodiments, the dielectric layer is acquired from a manufacturer with a layer of copper already disposed thereon. Thus, in some instances, the process does not include a step of disposing a layer of ½ ounce CU between the second bond layer 702D and the fourth core dielectric layer 712.

In some embodiments, processing the artificial dielectric layer 745 (step 842) can include ensuring that the thickness of the artificial dielectric layer 745 is selected to provide a wide-angle impedance matching (WAIM). In these embodiments, the artificial dielectric layer 745 can be referred to as the WAIM layer.

Once the layers of the artificial dielectric layer 745 are processed (step 842), the artificial dielectric layer 745 is laminated together with the combined structure 830 of the dipole layer 735 and the lower conductive assembly 720 (step 844) using any of the lamination methods described herein. When lamination is complete, the resulting structure is a fully assembly radiator 840. This radiator 840 can be mounted to a metal base 705 and otherwise processed to create the array antenna element 700.

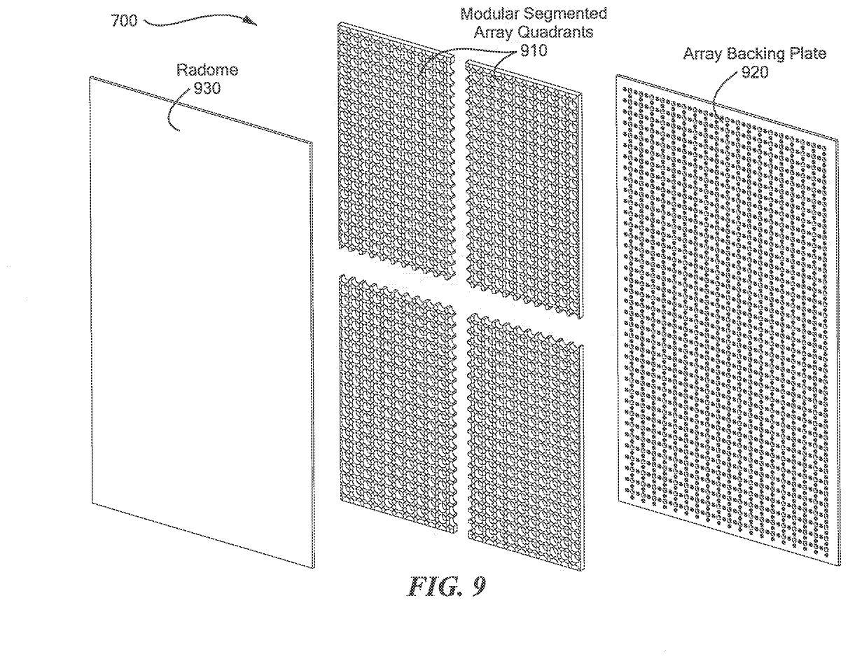

Illustrated in FIG. 9 is one view of the elements of a fully assembled array antenna element 700. Shown is an array backing plate 920 which can be a metal substrate such as an aluminum base 705 or any other backing that can provide insulation, protection and rigidity to the array antenna element 700.

FIG. 9 illustrates one embodiment of how the array antenna element 700 can be segmented into four quadrants 910. It should be appreciated that the array antenna element 700 can be segmented into any number of segments that have any geometry. What is shown, however, are the various cut planes through which the array antenna element 700 can be cut or segmented into various modular pieces.

In some embodiments, an enclosure or other type of protective coating can be applied to the array antenna element 700. For example, FIG. 9 illustrates the application of a radome 930 to the antenna element 700. It should be appreciated that the radome 930 is merely protective and is preferably manufactured from a material that minimally attenuates the electromagnetic signals transmitted and received by the array antenna element 700.

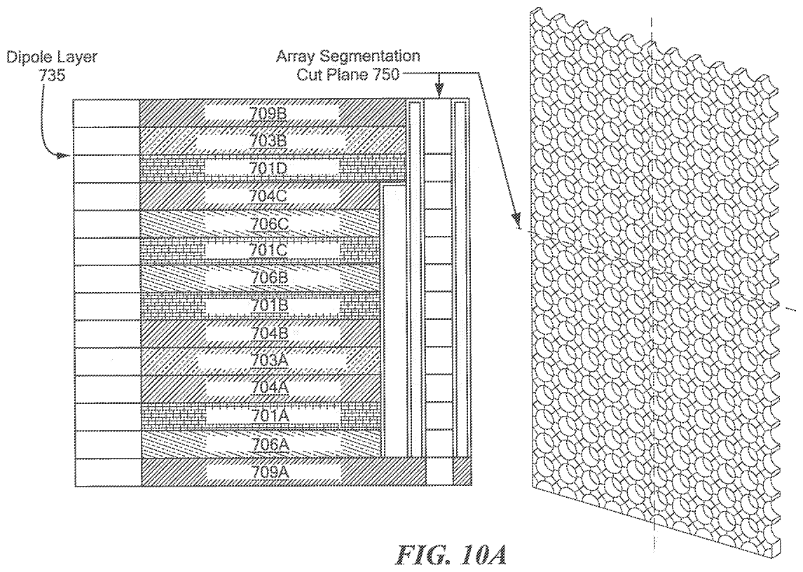

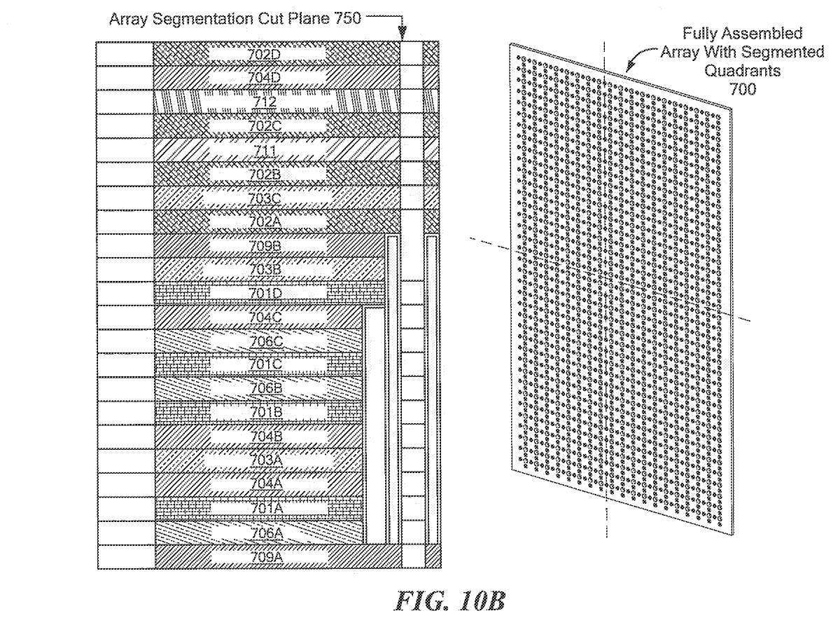

Illustrated in FIG. 10A is one embodiment of a partially constructed antenna array element 700. Illustrate is the dipole layer 735 having an array segmentation cut plane 750. FIG. 10B illustrates the partially constructed antenna array element 700 of FIG. 10A with an artificial dielectric layer 745 disposed on the dipole layer 735. Also illustrated is the array segmentation cut plane 750. It should be appreciated that the antenna array element 700 can be any geometry or size and can comprise any number of cut planes 750 arranged in any pattern or shape.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A radio frequency (RF) array antenna element comprising:
a multi-layer printed circuit board (PCB) having disposed thereon a plurality of dual-polarized antenna elements with each of the dual-polarized antenna elements disposed to define a segmentation cut plane therebetween to enable size modification and modular construction of the RF array antenna; and
an artificial dielectric layer (ADL) disposed on the plurality of antenna elements, wherein the ADL comprises one or more dielectric layers and one or more metallic surface layers disposed thereover.

2. The RF array antenna element of claim 1, wherein the segmentation cut plane is aligned in a region of the dual-polarized antenna elements which is non-conductive.

3. The RF array antenna element of claim 1, wherein the multi-layer printed circuit board (PCB) comprises:
a lower conductive assembly having first and second opposing surfaces;
a dipole layer having first and second opposing surfaces with the first surface disposed over the second surface of the lower conductive assembly and wherein:
the ADL has first and second opposing surfaces with the first surface of the ADL disposed over the second surface of the dipole layer; and
the segmentation cut plane extends from the second surface of the ADL through the first surface of the lower conductive assembly.

4. The RF array antenna of claim 3, wherein the segmentation cut plane is disposed between first and second conductive vias which extend from the second surface of the dipole layer to the first surface of the lower conductive assembly.

5. A unit cell for use in a radio frequency (RF) array antenna, the unit cell comprising:
a multi-layer printed circuit board, having a first layer corresponding to an antenna element layer with the antenna element layer having disposed thereon one or more conductors responsive to RF signals having first and second orthogonal polarizations with the one or more conductors disposed to define a segmentation cut plane;
the multi-layer printed circuit board having one or more secondary layers corresponding to feed layers and having two or more feed circuits disposed thereon with a first one with the two or more feed circuits electrically coupled to a first one of the conductors and responsive to signals having a first polarization and a second one with the two or more feed circuits electrically coupled to a second one of the conductors and responsive to signals having a second polarization which is orthogonal to the first polarization, the two or more feed circuits disposed to define a segmentation cut plane which is aligned with the segmentation cut plane defined by the conductive elements disposed on the antenna element layer.
an artificial dielectric layer (ADL) disposed on the plurality of antenna elements, wherein the ADL comprises one or more dielectric layers and one or more metallic surface layers disposed thereover with conductors on the metallic surface layers configured such that a conductor crosses the segmentation cut plane defined by the conductive elements disposed on the antenna element layer and the feed circuits of the feed circuit layers.

6. The unit cell of claim 5 wherein the antenna element and the feed circuit are disposed such that the segmentation cut plane does not cross any conductive elements.

7. The unit cell of claim 6 wherein the feed circuit comprises a coaxial signal path.

8. The unit cell of claim 6, wherein the segmentation cut plane is non-conductive.

9. The unit cell of claim 6, wherein the one or more conductors are printed circuit conductors.

10. The unit cell of claim 6, wherein the antenna element layer is provided as a dipole layer.

11. The unit cell of claim 6, wherein the feed layer is provided as a dipole layer.

12. The unit cell of claim 6, wherein the multi-layer printed circuit board comprises:
a lower conductive assembly having first and second opposing surfaces;
a dipole layer having first and second opposing surfaces with the first surface of the diploe layer disposed over the second surface of the lower conductive assembly and wherein:
the ADL has first and second opposing surfaces with the first surface of the ADL disposed over the second surface of the dipole layer; and
the segmentation cut plane extends from the second surface of the ADL through the first surface of the lower conductive assembly.

13. The unit cell of claim 5, wherein the segmentation cut plane is between first and second conductive vias which extend from the second surface of the dipole layer to the first surface of the lower conductive assembly.

14. An array antenna comprising:
a plurality of antenna sections each comprising a plurality of unit cells, at least some of the unit cells having a segmentation cut plane with each of the unit cells having a segmentation cut plane comprising:
a multi-layer printed circuit board, having a first layer corresponding to an antenna element layer with the antenna element layer having disposed thereon one or more conductors responsive to RF signals having first and second orthogonal polarizations with the one or more conductors disposed to define a segmentation cut plane;
the multi-layer printed circuit board having one or more secondary layers corresponding to feed layers and having two or more feed circuits disposed therethrough with a first one of the secondary layers comprising the two or more feed circuits electrically coupled to a first one of the conductors and responsive to signals having a first polarization, and a second one of the secondary layers comprising two or more feed circuits electrically coupled to a second one of the conductors and responsive to signals having a second polarization which is orthogonal to the first polarization, the two or more feed circuits disposed to define a segmentation cut plane which is aligned with the segmentation cut plane defined by the conductive elements disposed on the antenna element layer,
an artificial dielectric layer (ADL) disposed on the plurality of antenna elements, wherein the ADL comprises one or more dielectric layers and one or more metallic surface layers disposed thereover with conductors on the metallic surface layers configured such that a conductor crosses the segmentation cut plane defined by the conductive elements disposed on the antenna element layer and the feed circuits of the feed circuit layers.

15. The array antenna of claim 14 wherein the one or more conductors disposed on the antenna element layer and the two or more feed circuits are disposed such that the segmentation cut plane does not cross any conductive elements.

16. The array antenna of claim 14 wherein each of the two or more feed circuits comprise a coaxial signal path.

17. The array antenna of claim 14, wherein the segmentation cut plane is non-conductive.

18. The array antenna of claim 14, wherein the one or more conductors are printed circuit conductors.

19. The array antenna of claim 14, wherein the multi-layer printed circuit board (PCB) comprises:
a lower conductive assembly having first and second opposing surfaces;
an antenna layer having first and second opposing surfaces with the first surface of the antenna layer disposed over the second surface of the lower conductive assembly and wherein:
the ADL has first and second opposing surfaces with the first surface of the ADL disposed over the second surface of the antenna layer; and
the segmentation cut plane extends from the second surface of the ADL through the first surface of the lower conductive assembly.

20. The array antenna of claim 14, wherein the lower conductive assembly comprises first and second conductive vias which extend from the second surface of the antenna layer to the first surface of the lower conductive assembly wherein the segmentation cut plane is in a plane between first and second conductive vias.
